(19) United States
(12) Patent Application Publication
(10) Pub. No.: US 2012/0034539 A1
(43) Pub. Date: Feb. 9, 2012

(54) HIGH EFFICIENCY AND RELIABLE FUEL CELL SYSTEM OPERATING AT NEAR 100% FUEL UTILIZATION

(76) Inventors: Raymond George, Pittsburgh, PA (US); Arun K.S. Iyengar, Delmont, PA (US); Daniel Danila, Jeannette, PA (US); Wayne Lundberg, Pittsburgh, PA (US)

(21) Appl. No.: 12/850,109

(22) Filed: Aug. 4, 2010

(51) Int. Cl. H01M 8/06

(52) U.S. Cl. 429/411

(57) ABSTRACT

A fuel cell system 110 containing fuel cells 120 contacted by hydrogen containing gaseous fuel, generating spent gaseous depleted fuel which is recirculated to a hydrogen separation system 143, preferably a heat exchanger 144 and condenser 148 to remove water 150, after which it is mixed with fresh fuel 116 and recirculated to the fuel cells 120.

### GOVERNMENT CONTRACT

The Government of the United States of America has rights in this invention pursuant to Contract No. DE-FC26-05NT42613 awarded by the U.S. Department of Energy.

### BACKGROUND OF THE INVENTION

1. Field of the Invention

The invention relates to a fuel cell spent fuel recirculation means including a hydrogen separation device such as a combined heat exchanger and water condenser to remove water from the depleted fuel and to increase fuel flow to the fuel cells in the fuel cell stack by increasing spent fuel recirculation. This can lead to lower fuel feed requirements resulting in higher electrical efficiency and increased reliability.

2. Description of Related Art

In general, beginning tubular Solid Oxide Electrolyte Fuel Cell (“SOFC”) art developed around 1980 by Westinghouse Electric Corporation as exemplified by Somers and Isenberg in U.S. Pat. No. 4,374,184. These fuel cells utilized thin film interior ceramic air electrodes, solid oxide ceramic solid electrolytes and exterior metal ceramic fuel electrodes, generally utilizing nickel metal particles; along with nickel interconnectors, all enclosed in an insulated enclosure operating at about 1,000° C. The enclosure was divided into a fuel oxidant reaction chamber generating chamber; combustion chamber for spent oxidant and spent fuel, useful to preheat feed oxidant; and more recently a spent fuel recirculation chamber. The main reactions are:

1) at the interior tubular air electrode O₂+4e^{-→2}O⁻

2) at the exterior tubular fuel electrode 2O⁻+H₂→H₂O+2e⁻.

Therefore, the main byproducts are water and electricity (e⁻). An exhaustive discussion of SOFC is found in J. Am. Ceram. Soc. 76[3] 563-88 (1993) by Nguyen Q. Minh, “Ceramic Fuel Cells.” In general, the SOFC electrolyte can be, for example, stabilized zirconia; the anode nickel/yttria-zirconia cermet and the cathode, air electrode, doped lanthanum manganite, among numerous materials, as is well known in the art.

Usually, the fuel cells have closed ends where oxidant was fed through a feed tube to reverse flow at the end of each fuel cell. Isenberg in U.S. Pat. No. 4,395,468 showed gas recirculation. Draper and George in U.S. Pat. No. 5,200,279, utilized open ended longer fuel cells up to 100 cm between tube sheets, where spent fuel from a top buffer chamber was recirculated to a bottom buffer chamber and spent fuel and exhausted recirculated oxidant were mixed in a pre-heat combustion chamber.

A variety of other patents, such as U.S. Pat. No. 5,573,867 and U.S. Pat. No. 6,572,996 (Zafred et al. and Isenberg et al., respectively), U.S. Patent Publication No. US2003/0054210A1 (Gillett et al.) show depleted fuel recirculation gases (containing H₂ and H₂O) passing to contact feed fuel in an exterior ejector containing a reformer section, to form H₂ from natural gas. This is then passed into the reaction plenum. Other patents in this area include U.S. Pat. No. 6,764,784 (Gillett) and U.S. Patent Publication Nos. US2004/0013913 and 2005/00123808 (Fabis et al. and Draper et al., respectively). Other patents show such operations internal to the fuel cells, such as U.S. Pat. No. 5,741,605 (Gillett et al.) and U.S. Pat. No. 5,733,675 (Dederer et al.). Iyengar and George et al., in recent U.S. Patent Publication No. 2007/0087254, teach introducing fuel into a mid-third section of a fuel cell apparatus after passing it through an external fuel ejector where the feed fuel mixes with spent fuel on a 1:1 volume basis, eliminating the need for seals in systems with open ended cells.

However, the prior art did not recognize that extracting the amount of water in the recirculated depleted fuel sent to mix with new incoming feed fuel would enhance the efficiency of the system by keeping the concentration of the fuel in the mix high. It was also not recognized that this would enhance the reliability of the system by making it less sensitive to stack fuel flow mal-distributions, at the high fuel utilizations now possible, which often can result in catastrophic fuel cell system failure.

FIG. 1A illustrates a general prior art fuel cell system 10, where recirculated depleted fuel 12 contains, generally, about 88 vol. % H₂O and only 12 vol. % H₂. To get a bottom feed 14 of acceptable gaseous fuel, about 91 vol. % H₂ and only 9 vol. % H₂O, only a small amount of recirculation flow of depleted fuel 12 is permissible without adding massive amounts of new feed fuel 16 to the recirculation/fresh fuel channel 18. Increasing the recirculation flow rate or the fuel feed rates to the levels needed for making the system less sensitive to fuel flow mal-distributions would make the fuel cell system extremely inefficient. The fuel cells are shown as 20 having interior air electrodes 22 and exterior fuel electrodes 24 with solid electrolyte therebetween 26, generally shown in enlarged portion FIG. 1B. Recirculation chamber 28, combustion chamber 30, exhaust plenum 32, air inlet plenum 34, air feed tube 36, feed air 38, and module exhaust 40 are also shown in FIG. 1A, as is recirculated spent fuel feed tube 42. The flow velocity of the recirculated fuel is about 11% of the fresh fuel feed flow velocity in this case.

What is needed is a fuel cell system that runs more efficiently with faster recirculation of depleted fuel, and which requires less feed fuel to begin with.

It is a main object of this invention to provide a fuel cell system, be it tubular, triangular, square, flat plate or other configuration, which runs efficiently, where less fuel is expended, dramatically reducing costs of the system, the fuel itself, and any pre-processing the fuel such as to reduce sulfur. It is another object of this invention to promote reliability of the system.

### SUMMARY OF THE INVENTION

The above needs are met and objects accomplished by providing a fuel cell system, preferably a solid oxide fuel cell system, operating on gaseous oxidant and a hydrogen containing gaseous fuel, each gas contacting fuel cells in the system, where the gaseous fuel reacts to generate a gaseous depleted fuel which contains water, wherein said spent gaseous depleted fuel is recirculated into a recirculation subsystem, having:

1) a hydrogen/water separator to separate water from the gaseous depleted fuel to provide hydrogen rich gaseous recirculated fuel;

2) a feed flow to mix the hydrogen rich gaseous recirculated fuel with fresh feed fuel to provide enhanced feed fuel; and

3) a feed flow to the fuel cells to pass the enhanced feed fuel to the fuel cells, where the recirculated spent gaseous depleted fuel contains no more than 45 vol. % water.

Preferably, the solid oxide fuel cell subsystem contains a heat exchanger and a condenser, where gaseous depleted fuel rich in water is passed from the heat exchanger into a stream passing to the condenser to remove water, after or before it combines with the fresh feed fuel and provide the desired enhanced feed fuel. The heat exchanger and condenser can be combined into one unit. Both are essential.

This much improved system preferably features a condenser in the recirculated depleted gaseous fuel gas stream to extract a majority of its water content, thereby ensuring a high inlet mole-fraction of H₂ in the fuel entering the stack. This, along with high recirculated fuel flow rates, while greatly increasing the average Nernst potential across the cell, permits the fuel cell system to run at high values of system fuel utilization. As a consequence, the electrical efficiency of the cell and the resulting system are considerably higher. Furthermore, the increased recirculation results in a low value of in-stack fuel consumption making the system more robust to fuel flow mal-distributions.

### BRIEF DESCRIPTION OF THE DRAWINGS

The advantages, nature and additional features of the invention will become more apparent from the following description, taken in combination with the accompanying drawings, in which:

FIG. 1A is a schematic illustration of a prior art H₂ fueled SOFC system with anode gas recirculation;

FIG. 1B is an expanded cross-sectional view of a fuel cell wall;

FIG. 2 is a schematic illustration of the SOFC system of this invention, showing the preferred subsystem with a high circulation anode gas recirculation to a preferred heat exchanger/condenser combination;

FIG. 2B is an expanded cross-sectional view of a fuel cell wall;

FIG. 3 is a graph of a theoretical calculation of efficiency for different stack inlet H₂ mole fractions where fuel utilization=1;

FIG. 4 is a graph of predicted efficiency for a stack inlet H₂ mole fraction=92.5% and fuel utilization=1; and

FIG. 5 is a graph of predicted efficiency for a stack inlet H₂ mole fraction=92.5% and fuel utilization=0.96.

### DESCRIPTION OF THE PREFERRED EMBODIMENTS

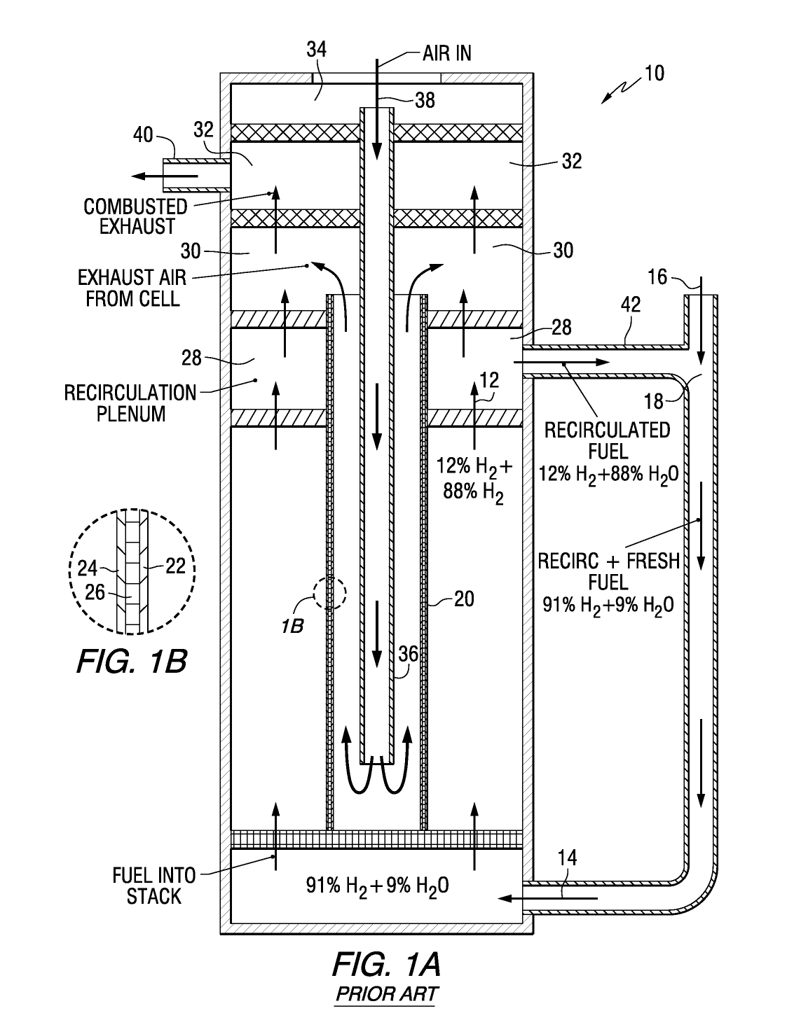

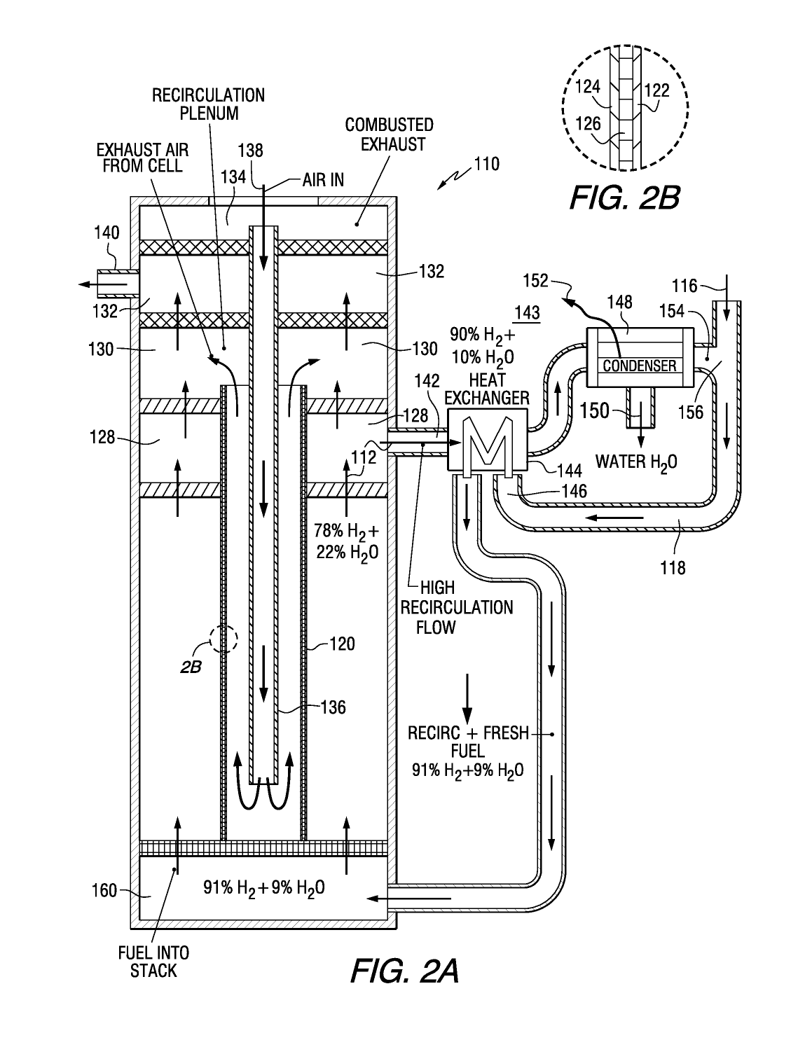

The prior art FIG. 1A and FIG. 1B has already been discussed. FIG. 2A illustrates the SOFC system 110 of this invention where spent depleted fuel 112 contains, generally only about 22 vol. % H₂ and 78 vol. % H₂ even at the higher recirculation rate. Consequently, higher electrochemical fuel utilizations can be realized and much lower amounts of new fuel 116 must be added to the recirculation/fresh fuel channel 118. The fuel cells are shown as 120 having interior air electrodes 122 and exterior fuel electrodes 124 with solid electrolyte therebetween 126, generally shown in expanded portion FIG. 2B. Recirculation chamber 128, combustion chamber 130, exhaust plenum 132, air inlet plenum 134, air feed tube 136, feed air 138, and module exhaust 140 are also shown in FIG. 1A. Of course, there will be a plurality of fuel cells 120 to provide a fuel cell stack.

Also shown is high recirculation spent fuel feed tube 142 passing into hydrogen separation system 143, preferably, into a heat exchanger 144 where a mixture of fresh fuel and recirculated fuel-enhanced feed fuel 146 as is heated to ensure that the recirculated mix enters the fuel cell stack at a suitable temperature. This keeps the heat, which otherwise would have been lost, within the module and obviates the need for a separate fuel heater. The recirculated spent gaseous depleted fuel 112 is recirculated into high recirculation spent fuel tube 142, after being cooled in heat exchanger 144, passes to condenser 148, where water 150 is extracted and low grade heat 152 is rejected. This provides hydrogen rich gaseous depleted fuel 154 which contains from 8 vol. % to 12 vol. % H₂ and 88 vol. % to 92 vol. % H₂, which directly mixes with new fresh feed fuel 116 at point 156 to provide enhanced feed fuel 146 which contains 10 vol. % to 7 vol. % H₂ and 90 vol. % to 93 vol. % H₂ which is fed to the heat exchanger 144 to be heated and then fed to the exterior of the fuel cells 120, preferably through fuel feed plenum 160. The enhanced feed fuel 146 has increased recirculation.

The heat exchanger 144 and condenser 148 have never been considered before because the advantages of extraction of the water from the recirculated stream were not recognized earlier. They are now found critical because of the potential to achieve high system efficiencies, especially in coal derived syngas applications. In addition, the relative insensitivity of the system to fuel flow mal-distributions practically realizable in commercial systems is of great importance to the reliability of the complete system.

Use of this combination allows, in theory an infinitely high recirculation flow rate in the recirculated depleted fuel feed tube 142 allowing almost complete utilization of the fresh fuel with the thermodynamically efficient electrochemical process. Even with practical considerations an efficiency boost of over 12 percentage points can be realized.

More generally, the recirculating spent fuel 112 flow is passed through a recuperative heat exchanger (for sensible heat removal) and a condenser to extract a major portion of its water content. A H₂/water separator, which might not require cooling the stream to room temperatures, may also be used instead of the condenser and might be beneficial from a system performance perspective. The drier gas, rich in H₂, is then mixed with fresh fuel and fed back to the stack. With this system one can use large recirculation flow rates without affecting the stack inlet fuel concentration. The fuel mole fractions for a practical recirculation rate corresponding to a recirculation flow that is roughly 8 times the incoming fresh fuel flow are also shown in the figure. Although the fuel utilization is nearly equal to 1 for the depicted case, the open end (OE) fuel mole fraction is about 78% corresponding to a stack average fuel mole fraction of about 84.5%. Both the increased fuel utilization and the increased average fuel mole-fraction (and hence the average Nernst potential) result in a considerable increase in the fuel cell electric efficiency. In theory, in the limit, a fuel utilization value of 1 is possible with infinite recirculation (a recirculation fraction of 1) where the OE Nernst potential will be equal to the CE Nernst potential.

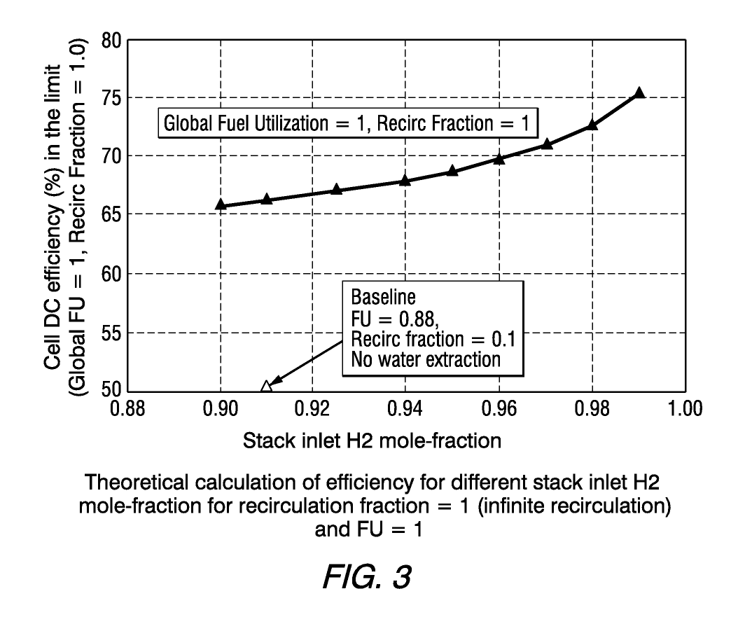

FIG. 3 shows a plot of the potentially achievable cell electric (DC) efficiencies as a function of the stack inlet mole-fraction for infinite recirculation along with a fuel utilization value of 1. The cell DC efficiency of the conventional baseline system with FU=0.88 and recirculation fraction=0.1 is also shown on the figure. The potential of the proposed system to raise the cell DC efficiency is immediately evident as gains of more than 15 percentage points (from 50% to 65% DC efficiency) can be theorized. However, practical heat exchange sources available in the system for water extraction limit the condenser outlet H₂ mole-fraction to about 93%.

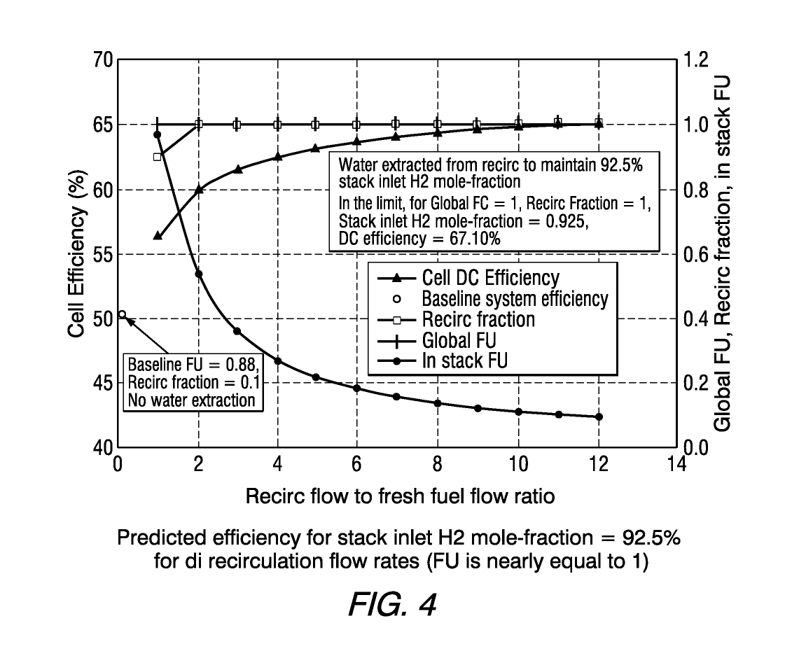

FIG. 4 shows the cell DC efficiency of a system with a fixed inlet mole-fraction of about 92.5% as a function of the recirculation flow rate defined by the ratio of the recirculation flow rate to the fresh fuel flow rate. Keeping in mind that the conventional systems have shown an ability to recirculate about 8-9 times the fresh fuel flow rate, it is evident from this figure that an efficiency boost of about 14% (from 50% to 64% DC efficiency) over the baseline system is realizable. Note that the fuel utilization on this chart is nearly equal to 1, which may be difficult to achieve practically.

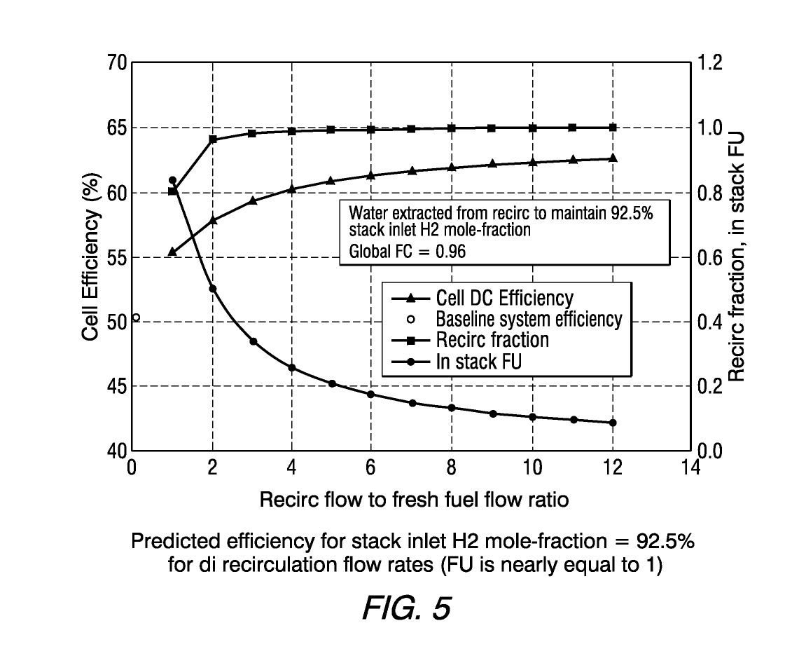

Accordingly, FIG. 5 shows the corresponding results for a fuel utilization of about 96%. Even for this case (at the recirculation flow to fresh fuel flow ratio of 8) the efficiency is about 12 percentage points higher (from 50% to 62%) than the baseline system value. Further, the in-stack fuel consumption at this point is only 0.13, which should go a long way in making the system robust to fuel side flow mal-distributions.

It is clear from these results that the proposed system results in a considerable efficiency advantage and seems to be robust to fuel mal-distribution issues. It also lends itself well to a separated anode and cathode gas system. Part of the heat rejected in the water extraction process can be used to heat the fuel entering the stack. The rest of it can be used to preheat SOFC process air, heat water or generate steam in a CHP system, heat condensate and generate steam for a conventional Rankine bottoming cycle, or be the heat source for an organic Rankine cycle, all contributing to achieving highest system electric or overall energy efficiency. Further taking the heat out by condensing the water should lower module airflow requirements thereby resulting in an additional increase in the overall system efficiency.

The technique is also applicable to both pressurized as well as atmospheric SOFC system. In fact, in a pressurized SOFC system, the latent heat of vaporization in the recirculation flow would become thermally available at a higher temperature, which tends to benefit bottoming cycle performance. Finally, it should be noted that this concept is applicable in general to other fuel cell (non solid-oxide) systems.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A fuel cell system operating on gaseous oxidant and a hydrogen containing gaseous fuel, each gas contacting fuel cells in the system where the gaseous fuel reacts to generate a spent gaseous depleted fuel which contains water, wherein said spent gaseous depleted fuel is recirculated into a recirculation subsystem excluding an ejector, having:
1) a hydrogen separator to separate water from the spent gaseous depleted fuel to provide hydrogen rich gaseous depleted fuel;
2) a feed flow to mix the hydrogen rich gaseous depleted fuel with fresh feed fuel to provide enhanced feed fuel; and
3) a feed flow to the fuel cells to pass the enhanced feed fuel to the fuel cells, where the recirculated spent gaseous depleted fuel sent to the hydrogen separator contains no more than 45 vol. % water.

2. The fuel cell system of claim 1, wherein the subsystem contains a heat exchanger and a condenser, where spent gaseous depleted fuel is passed from the heat exchanger into a stream passing to the condenser to remove oxygen, and afterwards to combine with the fresh feed fuel and provide the enhanced feed fuel.

3. The fuel cell system of claim 2, wherein the spent gaseous depleted fuel heats the enhanced feed fuel in the heat exchanger.

4. The fuel cell system of claim 2, wherein the enhanced feed fuel is heated in the heat exchanger to ensure it passes to the fuel cells at a suitable temperature.

5. The fuel cell system of claim 1, wherein the water content of the spent gaseous depleted fuel is below 45 vol. %.

6. The fuel cell system of claim 1, wherein the subsystem contains a heat exchanger and a condenser, wherein the condenser extracts a majority of the water content of the spent gaseous depleted fuel ensuring a high inlet mole fraction of H₂ in the enhanced feed fuel.

7. The fuel cell system of claim 1, wherein the hydrogen rich gaseous depleted fuel containing from 8 vol. % to 12 vol. % H₂ and 88 vol. % to 92 vol. % H₂.

8. The fuel cell system of claim 1, wherein fuel flow to the fuel cells is increased due to increased recirculation of the enhanced feed fuel.

9. The fuel cell system of claim 1, wherein the fuel cells are solid oxide fuel cells.

10. The fuel cell system of claim 9, wherein the fuel cells are tubular.
